(19) United States
(12) Patent Application Publication
(10) Pub. No.: US 2023/0399017 A1
(43) Pub. Date: Dec. 14, 2023

(54) AUTOMATIC OPERATING SYSTEM, SERVER, AND METHOD FOR GENERATING DYNAMIC MAP

(71) Applicant: Mitsubishi Electric Corporation, Tokyo (JP)

(72) Inventor: Tetsuro NISHIOKA, Tokyo (JP)

(73) Assignee: Mitsubishi Electric Corporation, Tokyo (JP)

(21) Appl. No.: 18/033,674

(22) PCT Filed: Dec. 4, 2020
(86) PCT No.: PCT/JP2020/045316

§ 371 Date: Apr. 25, 2023

(51) Int. Cl. B60W 60/00; B60W 30/095; G08G 1/16; G01C 21/34

(52) U.S. Cl. CPC B60W 60/0015; B60W 30/095; G08G 1/164; G01C 21/3415; G06V 20/58

(57) ABSTRACT

A motion prediction unit that predicts a motion of a mobile object on the basis of sensor information; a range prediction unit that predicts a virtual obstacle range in which a virtual obstacle is present on the basis of motion prediction information regarding the motion of the mobile object predicted by the motion prediction unit; and a map generation unit that generates a dynamic map reflecting the virtual obstacle range on the basis of information regarding the virtual obstacle range predicted by the range prediction unit.

### TECHNICAL FIELD

The present disclosure relates to an automatic operating system, a server that generates a dynamic map, and a method for generating a dynamic map by the server.

### BACKGROUND ART

A dynamic map used in automatic operation is known.

The dynamic map is a digital map generated by superimposing semi-static information such as a scheduled construction or a scheduled lane restriction, semi-dynamic information such as a construction section or a lane restriction, and dynamic information of a vehicle, a pedestrian, or the like on a high-precision three-dimensional map. A vehicle capable of automatic operation performs automatic operating control while collating information on the dynamic map with information detected by a sensor mounted on the vehicle. This makes it possible to grasp dynamic information in a blind spot or in a wide range that cannot be observed by a single vehicle, leading to implementation of high-precision automatic operating control.

Meanwhile, as a technique of performing operating assistance on the basis of a map reflecting dynamic information, for example, Patent Literature 1 discloses a technique of determining a combination of actions having a possibility of collision between mobile objects from actions of the mobile objects predicted on the basis of dynamic information, generating instruction information indicating an event that triggers an action indicated by the combination and processing to be executed when the event occurs, and transmitting the instruction information to an in-vehicle device of a vehicle having a possibility of collision.

### CITATION LIST

### Patent Literature

Patent Literature 1: JP 2020-101986 A

### SUMMARY OF INVENTION

### Technical Problem

In a conventional automatic operating system using a dynamic map, since a dynamic map provided to a vehicle capable of automatic operation is associated with information at the current time, the vehicle cannot make, for example, an operating plan to avoid a sudden change in the situation that may occur in the future. As a result, there is a problem that the vehicle may be abruptly controlled, for example, when there is a sudden change in the situation around the vehicle.

Note that, in such a technique as disclosed in Patent Literature 1 described above, behavior of a mobile object is predicted on the basis of dynamic information. However, the prediction performed by the technique means that a pattern of a motion that can be taken by the mobile object is prepared from the current position and speed of the mobile object, and does not uniquely predict a direction in which the mobile object actually moves. Therefore, when a motion actually taken by the mobile object is not the motion of the prepared pattern, an in-vehicle device that has received instruction information cannot cope with this situation, and may take abrupt control of the vehicle.

The present disclosure has been made in order to solve the above problems, and an object of the present disclosure is to provide an automatic operating system that provides a generated dynamic map to a vehicle capable of automatic operation, and can avoid sudden control of the vehicle capable of automatic operation.

### Solution to Problem

An automatic operating system according to the present disclosure is an automatic operating system that provides a generated dynamic map to a vehicle capable of automatic operation, the automatic operating system including: a motion prediction unit that predicts a motion of a mobile object on the basis of sensor information; a range prediction unit that predicts a virtual obstacle range in which a virtual obstacle is present on the basis of motion prediction information regarding the motion of the mobile object predicted by the motion prediction unit; and a map generation unit that generates the dynamic map reflecting the virtual obstacle range on the basis of information regarding the virtual obstacle range predicted by the range prediction unit.

### Advantageous Effects of Invention

According to the present disclosure, in an automatic operating system that provides a generated dynamic map to a vehicle capable of automatic operation, sudden control of the vehicle capable of automatic operation can be avoided.

### BRIEF DESCRIPTION OF DRAWINGS

FIG. 1 is a diagram illustrating a configuration example of an automatic operating system according to a first embodiment.

FIG. 2 is a diagram illustrating a concept of an example of integrated virtual obstacle range information in the first embodiment.

FIG. 3 is a diagram illustrating a concept of an example of a dynamic map group including a current time dynamic map and a plurality of future dynamic maps generated by a map generation unit in the first embodiment.

FIG. 4 is a diagram illustrating a concept of an example of a route planned by an in-vehicle device in the first embodiment.

FIG. 5 is a flowchart for explaining an operation of a server according to the first embodiment.

FIG. 6 is a flowchart for explaining an operation of an in-vehicle device according to the first embodiment.

FIG. 7 is a flowchart for explaining an operation of a behavior observation device according to the first embodiment.

FIG. 8 is a sequence diagram for explaining an image of an operation of an automatic operating system in the first embodiment.

FIGS. 9A and 9B are each a diagram illustrating an example of a hardware configuration of the server according to the first embodiment.

FIG. 10 is a diagram illustrating a configuration example of an automatic operating system in which a server has a function of a motion prediction unit in the first embodiment.

FIG. 11 is a sequence diagram for explaining an image of an operation of an automatic operating system in which the behavior observation device outputs motion prediction information as a preliminary value to the in-vehicle device in the first embodiment.

FIG. 12 is a sequence diagram for explaining an image of an operation of the automatic operating system in a case where the behavior observation device is applied to a bus operating system in the first embodiment.

FIG. 13 is a diagram illustrating a concept of an example of a dynamic map group including a current time dynamic map and a plurality of future dynamic maps generated by the server in a case where the behavior observation device is applied to a bus operating system in the first embodiment.

FIG. 14 is a diagram illustrating a concept of an example of a route planned by the in-vehicle device on the basis of a dynamic map group generated by the server in a case where the behavior observation device is applied to a bus operating system in the first embodiment.

### DESCRIPTION OF EMBODIMENTS

Hereinafter, an embodiment of the present disclosure will be described in detail with reference to the drawings.

### First Embodiment

An automatic operating system according to a first embodiment provides a generated dynamic map to a vehicle capable of automatic operation (hereinafter, referred to as “automatic operating vehicle”).

The dynamic map is a digital map generated by associating various pieces of information regarding road traffic such as information of surrounding vehicles or traffic information in real time with a high-precision three-dimensional map on which a vehicle can specify the position of the host vehicle related to a road or surroundings of the road at a lane level.

The dynamic map includes static information, semi-static information, semi-dynamic information, and dynamic information.

The static information is high-precision three-dimensional map information.

The semi-static information includes information regarding a schedule of traffic regulations, information regarding a schedule of road construction, wide area weather forecast information, and the like.

The semi-dynamic information includes accident information, congestion information, traffic regulation information, road construction information, narrow area weather forecast information, and the like.

The dynamic information includes, for example, information regarding a vehicle, a pedestrian, or a signal collected from a sensor included in a roadside device, an in-vehicle device, or the like.

The dynamic map is generated by associating the semi-static information, the semi-dynamic information, and the dynamic information with high-precision three-dimensional map information that is the static information. Note that an association rule for associating the semi-static information, the semi-dynamic information, and the dynamic information with the high-precision three-dimensional map information is preset.

The dynamic map is used in automatic operation. Specifically, an automatic operating vehicle performs automatic operating control, for example, while collating information on the dynamic map with information acquired from a sensor mounted on the automatic operating vehicle. The automatic operating vehicle can grasp dynamic information and the like in a blind spot or in a wide range that cannot be observed by a single vehicle, and can implement high-precision automatic operating control, by traveling while collating various pieces of information associated in real time on the dynamic map with information acquired from the sensor.

Meanwhile, conventionally, the dynamic map reflects only a situation at the current time. Therefore, the automatic operating vehicle cannot make an operating plan that avoids a sudden change in the situation that may occur in the future. As a result, the automatic operating vehicle may be suddenly controlled when a sudden change in the situation occurs around the automatic operating vehicle, such as occurrence of an event in which the automatic operating vehicle is likely to collide with another mobile object. The sudden control of the automatic operating vehicle may lead to an increased burden on an occupant.

Therefore, the automatic operating system according to the first embodiment can avoid the sudden control of the automatic operating vehicle by generating dynamic maps after the current time, reflecting information based on a future motion of the mobile object.

Note that, in the following first embodiment, a “mobile object” also includes a person. In addition, in the following first embodiment, a “motion of a mobile object” also includes a motion of a part of the mobile object such as a door of a vehicle.

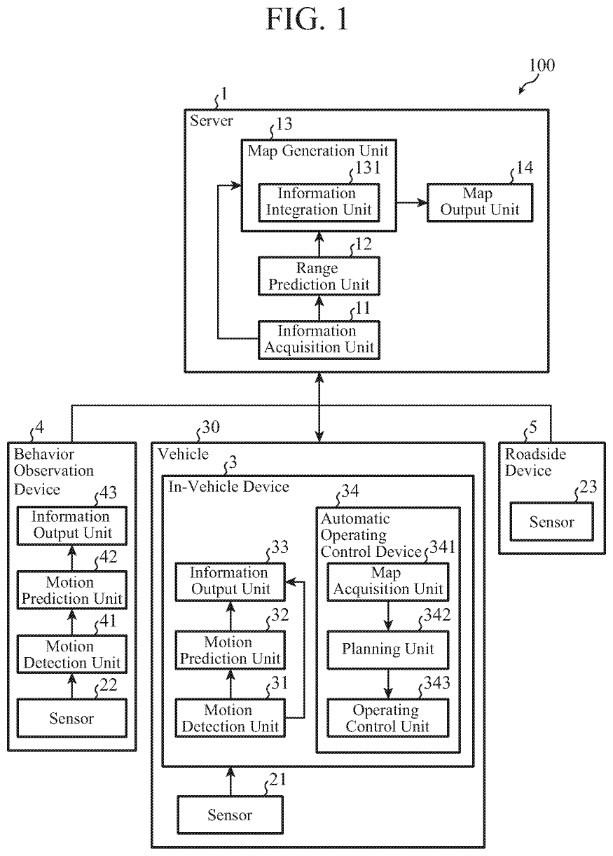

FIG. 1 is a diagram illustrating a configuration example of an automatic operating system 100 according to the first embodiment.

The automatic operating system 100 includes a server 1, an in-vehicle device 3 mounted on a vehicle 30, a behavior observation device 4, and a roadside device 5.

Detailed configurations of the server 1, the in-vehicle device 3, the behavior observation device 4, and the roadside device 5 will be described later. First, outlines of the in-vehicle device 3, the behavior observation device 4, the roadside device 5, and the server 1 will be described in the order of the in-vehicle device 3, the behavior observation device 4, the roadside device 5, and the server 1.

The in-vehicle device 3 predicts motions of a mobile object after the next time on the basis of sensor information acquired from a sensor 21 included in the vehicle 30. The sensor 21 is, for example, a LiDAR or a millimeter wave radar. Note that the sensor 21 may be included in the in-vehicle device 3.

The in-vehicle device 3 outputs information regarding the predicted motion of the mobile object (hereinafter, referred to as “motion prediction information”) to the server 1.

In addition, the in-vehicle device 3 outputs the sensor information acquired from the sensor 21 to the server 1 at a preset cycle.

Note that only one vehicle 30 is illustrated in FIG. 1, but this is merely an example. In the automatic operating system 100, a plurality of the vehicles 30 can be connected to the server 1.

In addition, the vehicle 30 illustrated in FIG. 1 is assumed to be an automatic operating vehicle, but the vehicles 30 connected to the server 1 may include a vehicle 30 that does not have an automatic operating function. Note that, in the automatic operating system 100, it is assumed that at least one automatic operating vehicle is connected to the server 1.

The behavior observation device 4 includes a sensor 22, and predicts motions of a mobile object after the next time on the basis of sensor information acquired from the sensor 22. In the first embodiment, as an example, it is assumed that the behavior observation device 4 is mounted on a fare adjustment machine (not illustrated) of a parking lot facing a public road. Note that this is merely an example, and the behavior observation device 4 is mounted on various devices, detects a motion of a mobile object at a certain time point, and predicts motions of the mobile object after the next time of the certain time point using the detected motion as a trigger.

The sensor 22 is, for example, a camera, a touch sensor, or a human sensor. Note that the sensor 22 may be included in the fare adjustment machine.

The behavior observation device 4 outputs motion prediction information regarding the predicted motion of the mobile object to the server 1.

Note that only one behavior observation device 4 is illustrated in FIG. 1, but this is merely an example. In the automatic operating system 100, a plurality of the behavior observation devices 4 can be connected to the server 1.

The roadside device 5 includes a sensor 23 that detects a situation around a road, and outputs sensor information acquired from the sensor 23 to the server 1 at a preset cycle. The sensor information acquired from the sensor 23 includes, for example, information regarding a mobile object around a road.

Note that only one roadside device 5 is illustrated in FIG. 1, but this is merely an example. In the automatic operating system 100, a plurality of the roadside devices 5 can be connected to the server 1.

The server 1 is assumed to be a computing device disposed at each point, such as a cloud or multi-edge computing. The server 1 has sufficient arithmetic processing performance.

The server 1 acquires the motion prediction information output from the in-vehicle device 3 or the behavior observation device 4, and generates, on the basis of the acquired motion prediction information, a plurality of dynamic maps after the current time, reflecting dynamic information based on the motion prediction information.

In addition, the server 1 generates, on the basis of the sensor information output from the in-vehicle device 3 and the roadside device 5, a current time dynamic map reflecting dynamic information based on the sensor information.

The server 1 outputs the generated dynamic map group to the vehicle 30. Note that the vehicle 30 at this time is an automatic operating vehicle. The automatic operating vehicle that has acquired the dynamic map group makes an operating plan in automatic operation using the dynamic map group.

Configurations of the in-vehicle device 3, the behavior observation device 4, the roadside device 5, and the server 1 will be described in detail.

The in-vehicle device 3 includes a motion detection unit 31, a motion prediction unit 32, an information output unit 33, and an automatic operating control device 34.

The automatic operating control device 34 includes a map acquisition unit 341, a planning unit 342, and an operating control unit 343.

The motion detection unit 31 detects a motion of a mobile object on the basis of the acquired sensor information.

Specifically, for example, the motion detection unit 31 detects a motion of an occupant of the vehicle 30. The motion of the occupant detected by the motion detection unit 31 is, for example, a motion of opening and closing a door of the vehicle a motion of unlocking the door of the vehicle 30, a lighting operation, or a parking brake operation.

Here, as an example, detection of the motion of the mobile object by the motion detection unit 31 will be specifically described with an example in which the motion detection unit 31 detects an occupant's motion of opening a door of the vehicle 30. For example, the sensor 21 is disposed in a door knob. When sensor information indicating that a hand put on the door knob has been detected is output from the sensor 21, the motion detection unit 31 detects that an occupant has put his or her hand on the door knob on the basis of the sensor information.

The motion detection unit 31 outputs information indicating that the motion of the mobile object has been detected (hereinafter, referred to as “motion detection information”) to the motion prediction unit 32. In the above example, the motion detection unit 31 outputs, to the motion prediction unit 32, motion detection information indicating that touch of the occupant on the door knob has been detected. The motion detection information includes information regarding the time when the motion detection unit 31 detects the motion of the mobile object and the detected motion.

In addition, when acquiring the sensor information from the sensor 21, the motion detection unit 31 detects the motion of the mobile object as described above and also outputs the sensor information to the information output unit 33. The sensor information is information detected by the sensor 21 at the current time.

When the motion detection information is output from the motion detection unit 31, that is, when the motion detection unit 31 detects the motion of the mobile object on the basis of the sensor information, the motion prediction unit 32 predicts motions of the mobile object after the next time. Note that the mobile object whose motion has been detected by the motion detection unit 31 and the mobile object whose motions after the next time are predicted by the motion prediction unit 32 do not have to be the same mobile object.

Specifically, as in the above example, it is assumed that the motion detection unit 31 has detected touch of the occupant on the door knob. In this case, the motion prediction unit 32 predicts a period from the time when the occupant touches the door knob until the door is opened and the occupant gets off the vehicle.

For example, it is assumed that information associated with a period required from the time when the occupant touches the door knob until the door is opened and the occupant gets off (hereinafter, referred to as “getting-off period information”) is generated in advance for each vehicle 30 and is accumulated in a storage unit (not illustrated) that can be referred to by the in-vehicle device 3. For example, the period required from the time when the occupant touches the door knob until the occupant gets off varies depending on, for example, the age of the occupant.

For example, the motion prediction unit 32 calculates, on the basis of the getting-off period information, an average period of the periods required from the time when the occupant touches the door knob until the door is opened and the occupant gets off the vehicle, and predicts the average period as the period required from the time when the occupant touches the door knob until the door is opened and the occupant gets off the vehicle (hereinafter, referred to as “door opening period”). Note that it is assumed that the door is kept open from the time when the door is opened until the occupant gets off the vehicle. For example, the motion prediction unit 32 may predict, on the basis of the getting-off period information, the time at which the occupant gets off the vehicle after the occupant touches the door knob and the door is opened (hereinafter, referred to as “door opening time”).

The motion prediction unit 32 predicts a motion in which the door of the vehicle 30 opens after an elapse of the predicted door opening period from the time when the touch of the door knob is detected by the motion detection unit 31 or at the predicted door opening time. Note that, as described above, in the first embodiment, the “motion of a mobile object” also includes a motion of a part of the mobile object. Here, a motion of a door which is a part of the vehicle 30 is included in the motion of the vehicle 30.

The motion prediction unit 32 outputs the predicted motion prediction information regarding motions of the mobile object after the next time to the information output unit 33. In the above example, the motion prediction unit 32 outputs, to the information output unit 33, information indicating that the door of the vehicle 30 opens after an elapse of the predicted door opening period from the time when the occupant touches the door knob or at the predicted door opening time, as motion prediction information. The motion prediction information includes information regarding the time when the motion detection unit 31 detects the motion of the mobile object, in the above example, the time when the motion detection unit 31 detects touch of the occupant on the door of the vehicle 30.

The information output unit 33 outputs the motion prediction information output from the motion prediction unit 32 to the server 1. At this time, the information output unit 33 outputs the motion prediction information in association with information regarding the vehicle 30 or the in-vehicle device 3 (hereinafter, referred to as “vehicle information”). The vehicle information only needs to be output in association with the motion prediction information when the motion prediction unit 32 outputs the motion prediction information. The vehicle information includes, for example, information regarding the position of the vehicle and the type of the vehicle. The motion prediction unit 32 only needs to acquire, for example, information regarding the position of the vehicle and the type of the vehicle from, for example, the sensor 21.

The automatic operating control device 34 controls automatic operation of the vehicle 30.

The map acquisition unit 341 acquires a dynamic map group output from the server 1.

The map acquisition unit 341 outputs the acquired map group to the planning unit 342.

The planning unit 342 makes an operation plan on the basis of the dynamic map group acquired by the map acquisition unit 341. Specifically, the planning unit 342 plans a route on the basis of the dynamic map group acquired by the map acquisition unit 341.

The planning unit 342 outputs information regarding the planned route to the operating control unit 343.

The operating control unit 343 controls automatic operation on the basis of the route planned by the planning unit 342.

The behavior observation device 4 includes a motion detection unit 41, a motion prediction unit 42, and an information output unit 43.

The motion detection unit 41 acquires sensor information from the sensor 22, and detects a motion of a mobile object on the basis of the acquired sensor information. Note that a mobile object motion detection function of the motion detection unit 41 is similar to a motion detection function of the motion detection unit 31 included in the in-vehicle device 3.

Specifically, for example, the motion detection unit 41 detects a motion of a user in a parking lot. Specific examples of the motion of the user in the parking lot detected by the motion detection unit 41 include a motion in which the user pays his/her fare in the parking lot. For example, a fare adjustment button is displayed on a touch panel included in a fare adjustment machine, and the fare adjustment button includes the sensor 22. The sensor 22 is, for example, a touch sensor. The motion detection unit 41 acquires, as sensor information, operation information indicating that the touch sensor is operated.

When sensor information indicating that touch on the fare adjustment button has been detected is output from the sensor 22, the motion detection unit 41 detects that the user has touched the fare adjustment button and ended fare adjustment on the basis of the sensor information.

The motion detection unit 41 outputs motion detection information indicating that the motion of the mobile object has been detected to the motion prediction unit 42. In the above example, the motion detection unit 41 outputs, to the motion prediction unit 42, motion detection information indicating that the user has touched the fare adjustment button and ended fare adjustment.

When the motion detection information is output from the motion detection unit 41, that is, when the motion detection unit 41 detects the motion of the mobile object on the basis of the sensor information, the motion prediction unit 42 predicts motions of the mobile object after the next time. Note that the mobile object whose motion has been detected by the motion detection unit 41 and the mobile object whose motions after the next time are predicted by the motion prediction unit 42 do not have to be the same mobile object. A mobile object motion prediction function of the motion prediction unit 42 is similar to a motion prediction function of the motion prediction unit 32 included in the in-vehicle device 3.

Specifically, as in the above example, it is assumed that the motion detection unit 41 has detected that the user has touched the fare adjustment button and ended fare adjustment. In this case, the motion prediction unit 42 predicts a moving period required by the vehicle 30 from the time when the user ends fare adjustment until the vehicle 30 on which the user rides exits to a public road.

For example, it is assumed that information regarding a history of the moving period required from the time when the user ends fare adjustment in the parking lot until the vehicle 30 on which the user rides actually exits to a public road (hereinafter, referred to as “parking-lot-exiting history information”) is generated in advance and accumulated in a storage unit (not illustrated) that can be referred to by the behavior observation device 4. For example, the moving period required from the time when the user ends fare adjustment until the vehicle 30 exits to a public road varies depending on, for example, the nature of a driver.

For example, the motion prediction unit 42 calculates, on the basis of the parking-lot-exiting history information, an average period of the moving periods required from the time when the user ends fare adjustment until the vehicle 30 exits to a public road, and predicts the average period as a period required from the time when the user ends fare adjustment until the vehicle 30 exits to a public road (hereinafter, referred to as “parking-lot-exiting period”). For example, the motion prediction unit 42 may predict the time at which the vehicle 30 exits to a public road (hereinafter, referred to as “parking-lot-exiting time”) on the basis of the parking-lot-exiting history information.

The motion prediction unit 42 predicts a motion of the vehicle 30 in which the vehicle 30 exits to a public road after an elapse of the predicted parking-lot-exiting period from the time when an end of fare adjustment is detected by the motion detection unit 41 or at the predicted parking-lot-exiting time.

The motion prediction unit 42 outputs the predicted motion prediction information regarding motions of the mobile object after the next time to the information output unit 43. In the above example, the motion prediction unit 42 outputs, to the information output unit 43, information indicating that the vehicle 30 exits to a public road after an elapse of the predicted parking-lot-exiting period from the time when the user ends fare adjustment or at the predicted parking-lot-exiting time, as motion prediction information. The motion prediction information includes information regarding the time when the motion detection unit 41 detects a motion of a mobile object, in the above example, the time when the user ends fare adjustment.

The motion detection unit 41 and the motion prediction unit 42 will be described with other examples.

For example, the motion detection unit 41 detects a pedestrian. Here, it is assumed that the motion detection unit 41 detects a motion that a person is walking as a motion of a mobile object. As described above, in the first embodiment, a person is included in the mobile object.

For example, the sensor 22 is a camera. The motion detection unit 41 only needs to perform known image processing on a captured video captured by the camera and detect a pedestrian. Note that the motion detection unit 41 acquires a captured video of a plurality of frames from the camera. The motion detection unit 41 can detect a pedestrian in the captured video by performing known image processing on each of the frames and detecting a person.

The motion detection unit 41 outputs motion detection information indicating that the pedestrian has been detected to the motion prediction unit 42.

The motion prediction unit 42 predicts in which direction and at what speed the detected pedestrian is walking. As described above, since the motion detection unit 41 acquires a captured video of a plurality of frames from the camera, the motion prediction unit 42 can predict in which direction and at what speed the pedestrian is walking on the basis of the captured video of the plurality of frames acquired by the motion detection unit 41.

The motion prediction unit 42 predicts a motion of the pedestrian at what speed the pedestrian detected by the motion detection unit 31 is walking.

The motion prediction unit 42 outputs information indicating in which direction and at what speed the detected pedestrian is walking to the information output unit 43 as motion prediction information. The motion prediction information includes information regarding the time when the pedestrian is first detected by the motion detection unit 41.

The information output unit 43 outputs the motion prediction information output from the motion prediction unit 42 to the server 1. At this time, the information output unit 43 outputs the motion prediction information in association with information regarding the behavior observation device 4 (hereinafter, referred to as “behavior observation device information”). The behavior observation device information only needs to be output in association with the motion prediction information when the motion prediction unit 42 outputs the motion prediction information. The behavior observation device information includes the position of the behavior observation device 4, the type of the behavior observation device 4, a facility in which the behavior observation device 4 is disposed, information regarding a map of the facility or the like, and the like. The motion prediction unit 42 only needs to acquire the position of the behavior observation device 4, the type of the behavior observation device 4, a facility in which the behavior observation device 4 is disposed, information regarding a map of the facility or the like, and the like from, for example, the sensor 21.

The server 1 includes an information acquisition unit 11, a range prediction unit 12, a map generation unit 13, and a map output unit 14.

The map generation unit 13 includes an information integration unit 131.

The information acquisition unit 11 acquires motion prediction information and sensor information output from the in-vehicle device 3. The information acquisition unit 11 outputs the acquired motion prediction information and sensor information to the range prediction unit 12 while the motion prediction information and the sensor information are in association with each other. In addition, the information acquisition unit 11 outputs the acquired sensor information to the map generation unit 13.

In addition, the information acquisition unit 11 acquires motion prediction information output from the behavior observation device 4. The information acquisition unit 11 outputs the acquired motion prediction information to the range prediction unit 12.

In addition, the information acquisition unit 11 acquires sensor information output from the roadside device 5. The information acquisition unit 11 outputs the acquired sensor information to the map generation unit 13.

The range prediction unit 12 predicts a range in which a virtual obstacle is considered to be present (hereinafter, referred to as “virtual obstacle range”) on the basis of the motion prediction information acquired by the information acquisition unit 11 from the in-vehicle device 3 or the behavior observation device 4. In the first embodiment, the virtual obstacle range is a range assumed to be avoided for traveling due to occurrence of a certain event when the vehicle 30 travels. In the first embodiment, this certain event is assumed to be a virtual obstacle. Note that, in the first embodiment, a range of the virtual obstacle range is predetermined depending on, for example, a virtual obstacle.

Prediction of the virtual obstacle range by the range prediction unit 12 will be described with some specific examples.

### Specific Example 1

For example, it is assumed that motion prediction information indicating that a door of the vehicle 30 will open after an elapse of the door opening period from the time when the occupant touches a door knob is output from the in-vehicle device 3.

In this case, it is predicted that the door of the vehicle 30 will open when the door opening period elapses after the occupant touches the door of the vehicle 30. Therefore, the vicinity of the door of the vehicle 30 is assumed to be avoided for traveling while the door of the vehicle 30 is predicted to open after the occupant touches the door of the vehicle 30. That is, while the door of the vehicle 30 is predicted to open, a virtual obstacle can be considered to be present in a certain range near the door of the vehicle 30. In the first embodiment, this certain range in which a virtual obstacle is considered to be present is referred to as the “virtual obstacle range”.

For example, the range prediction unit 12 predicts a range having a radius of 7 m from the center of the vehicle 30 as the virtual obstacle range during a period from the time when the occupant touches the door of the vehicle 30 until the door opening period elapses. Note that the range prediction unit 12 only needs to specify the size of the door of the vehicle 30 from vehicle information output from the in-vehicle device 3 in association with the motion prediction information.

The range prediction unit 12 may change the size of the virtual obstacle range at the time when the occupant touches the door of the vehicle 30 and the size of the virtual obstacle range during a period from the next time of the time until the door opening period elapses. In the above example, for example, the range prediction unit 12 may set the virtual obstacle range at the time when the occupant touches the door of the vehicle 30 as a range having a radius of 1.5 m from the center of the door of the vehicle 30 in a front-rear direction with respect to a traveling direction of the vehicle.

### Specific Example 2

For example, it is assumed that motion prediction information indicating that the vehicle 30 will exit to a public road after an elapse of the parking-lot-exiting period from the time when the user ends fare adjustment is output from the behavior observation device 4.

In this case, it is predicted that the vehicle 30 will exit to the public road when the parking-lot-exiting period elapses after the user ends fare adjustment. Therefore, the vicinity of an exit from the parking lot to the public road is assumed to be avoided for traveling while the vehicle 30 is predicted to exit to the public road after the user ends fare adjustment.

For example, the range prediction unit 12 predicts a predetermined range in the vicinity of the exit of the parking lot as the virtual obstacle range during a period from the time when the user ends fare adjustment until the parking-lot-exiting period elapses. Note that the range prediction unit 12 only needs to specify a place where the behavior observation device 4 is disposed, that is, a place of the exit of the parking lot, from the behavior observation device information output from the behavior observation device 4 in association with the motion prediction information.

The range prediction unit 12 may change the size of the virtual obstacle range at the time when the user ends fare adjustment and the size of the virtual obstacle range during a period from the next time of the time until the parking-lot-exiting period elapses. In the above example, for example, the range prediction unit 12 may set the virtual obstacle range at the time when the user ends fare adjustment as a predetermined range at the exit of the parking lot.

### Specific Example 3

For example, it is assumed that motion prediction information indicating in which direction and at what speed a pedestrian is walking after the pedestrian is detected is output from the behavior observation device 4.

In this case, the vicinity of a place where a pedestrian is present is assumed to be avoided for traveling. Note that, in this case, it is assumed that the pedestrian continues walking. For example, the range prediction unit 12 sets a range in which the pedestrian is walking as the virtual obstacle range.

The range prediction unit 12 outputs information regarding the virtual obstacle range (hereinafter, referred to as “virtual obstacle range information”) to the map generation unit 13. The range prediction unit 12 associates, in the virtual obstacle range information, information at the time when the virtual obstacle range is predicted to appear, information that can specify the virtual obstacle range, and information regarding a mobile object that has caused appearance of the virtual obstacle range with each other.

Specifically, in the case of <Specific Example 1> described above, the range prediction unit 12 outputs, to the map generation unit 13, virtual obstacle range information in which a period from the time when the occupant touches the door of the vehicle 30 until the door opening period elapses, a range having a radius of 7 m from the center of the vehicle 30, and the vehicle information are associated with each other. In addition, the range prediction unit 12 outputs, to the map generation unit 13, virtual obstacle range information in which the time when the occupant touches the door of the vehicle 30, a range having a radius of 1.5 m from the center of the door of the vehicle 30 in a front-rear direction with respect to a traveling direction of the vehicle, and the vehicle information are associated with each other.

In addition, in the case of <Specific Example 2> described above, the range prediction unit 12 outputs, to the map generation unit 13, virtual obstacle range information in which a period from the time when the user ends fare adjustment until the parking-lot-exiting period elapses, a predetermined range in the vicinity of the exit of the parking lot, and the behavior observation device information are associated with each other. In addition, the range prediction unit 12 outputs, to the map generation unit 13, virtual obstacle range information in which the time when the user ends fare adjustment, the predetermined range in the exit of the parking lot, and the behavior observation device information are associated with each other.

In addition, in the case of <Specific Example 3> described above, the range prediction unit 12 outputs, to the map generation unit 13, virtual obstacle range information in which the time when the pedestrian has been detected, the range in which the pedestrian has been walking since the pedestrian was detected, and the behavior observation device information are associated with each other.

The map generation unit 13 generates a dynamic map reflecting a range of a virtual obstacle predicted by the range prediction unit 12 on the basis of the virtual obstacle range information output from the range prediction unit 12.

A method by which the map generation unit 13 generates the dynamic map will be described in detail.

First, the map generation unit 13 generates a current time dynamic map reflecting the current dynamic information on the basis of the sensor information output from the information acquisition unit 11. Note that, in addition to the current dynamic information, the map generation unit 13 reflects the current semi-dynamic information and the current semi-static information in the current time dynamic map. The map generation unit 13 acquires the semi-dynamic information or the semi-static information from, for example, a web server via the information acquisition unit 11. In FIG. 1, a web server or the like is not illustrated.

The information integration unit 131 of the map generation unit 13 combines the current semi-static information, the current semi-dynamic information, and the current dynamic information acquired via the information acquisition unit 11 with each other. Then, the map generation unit 13 generates a current time dynamic map reflecting the combined dynamic information, semi-static information, and semi-dynamic information in a high-precision three-dimensional map. Since a technique of generating the current time dynamic map on the basis of the sensor information and the like is a known technique, detailed description thereof is omitted.

Next, the map generation unit 13 generates a plurality of future dynamic maps reflecting the virtual obstacle range in time series for each predetermined time (map generation time g) after the current time.

First, the information integration unit 131 of the map generation unit 13 integrates the virtual obstacle range information output from the range prediction unit 12 and generates virtual obstacle range information after the integration (hereinafter, referred to as “integrated virtual obstacle range information”).

Specifically, the information integration unit 131 integrates the virtual obstacle range information in units of time in time series. That is, the information integration unit 131 combines pieces of virtual obstacle range information at the same time into one piece of integrated virtual obstacle range information.

For example, it is assumed that the following pieces of virtual obstacle range information are output from the range prediction unit 12.
Virtual obstacle range information in which a virtual obstacle range “a range having a radius of 7 m from the center of the vehicle 30”, a period from the time when the occupant touches a door knob of the vehicle 30 until the door opening period elapses “three seconds from 10:00:03”, and the vehicle information are associated with each other
Virtual obstacle range information in which a virtual obstacle range “a range having a radius of 1.5 m from the center of the vehicle 30 in a front-rear direction with respect to a traveling direction of the vehicle 30”, the time when the occupant touches a door knob of the vehicle 30 “10:00:03”, and the vehicle information are associated with each other
Virtual obstacle range information in which a virtual obstacle range “a predetermined range in the vicinity of the exit of the parking lot”, a period from the time when the user ends fare adjustment until the parking-lot-exiting period elapses “three seconds from 10:00:06”, and the behavior observation device information are associated with each other
Virtual obstacle range information in which a virtual obstacle range “a predetermined range in an exit of the parking lot”, the time when the user ends fare adjustment “10:00:06”, and the behavior observation device information are associated with each other

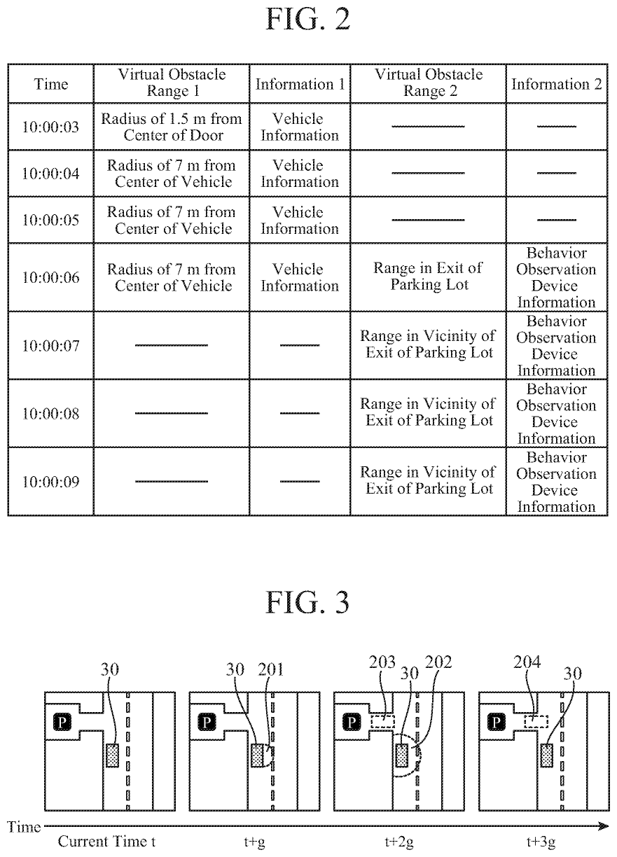

In this case, the information integration unit 131 generates integrated virtual obstacle range information of such an example illustrated in FIG. 2.

The map generation unit 13 generates a future dynamic map on the basis of the integrated virtual obstacle range information generated by the information integration unit 131.

Here, FIG. 3 is a diagram illustrating an example of a dynamic map group including a current time dynamic map and a plurality of future dynamic maps generated by the map generation unit 13 in the first embodiment. Note that the dynamic map is illustrated as a two-dimensional example in FIG. 3 for convenience of description.

In FIG. 3, the map generation unit 13 generates a dynamic map group including a dynamic map at the current time t and future dynamic maps corresponding to three times (time t+g, time t+2g, and time t+3g) for each map generation time g after the current time. Note that FIG. 3 illustrates an example of a dynamic map group in a case where the current time t is 10:00:00 and the map generation time g=three seconds.

In addition, in FIG. 3, the sensor information output from the information acquisition unit 11, that is, the sensor information at the current time t includes information indicating that one vehicle 30 (defined as a target vehicle) traveling on a road near the exit of the parking lot has been detected.

In addition, in FIG. 3, the integrated virtual obstacle range information has a content whose example is illustrated in FIG. 2.

As illustrated in FIG. 3, the map generation unit 13 generates, as a dynamic map at the current time t, here, 10:00:00, a dynamic map reflecting information of the target vehicle on the high-precision three-dimensional map. The map generation unit 13 can specify the position and size of the target vehicle from, for example, the area of the dynamic map, the scale of the dynamic map, and the sensor information.

In addition, the map generation unit 13 generates, as a future dynamic map at time t+g, here, 10:00:03, a dynamic map reflecting a virtual obstacle range (see a reference sign 201 in FIG. 3) having a radius of 1.5 m from the center of a door of the target vehicle on the high-precision three-dimensional map. The map generation unit 13 can specify the positions and sizes of the target vehicle and the virtual obstacle range from, for example, the area of the dynamic map, the scale of the dynamic map, and the vehicle information included in the integrated virtual obstacle range information.

In addition, the map generation unit 13 generates, as a future dynamic map at time t+2g, here, 10:00:06, a dynamic map reflecting a virtual obstacle range having a radius of 7 m from the center of the target vehicle (see a reference sign 202 in FIG. 3) and a preset range in an exit of the parking lot (see a reference sign 203 in FIG. 3) on the high-precision three-dimensional map. The map generation unit 13 can specify the positions and sizes of the target vehicle and the virtual obstacle range from, for example, the area of the dynamic map, the scale of the dynamic map, and the vehicle information and the behavior observation device information included in the integrated virtual obstacle range information.

In addition, the map generation unit 13 generates, as a future dynamic map at time t+3g, here, 10:00:09, a dynamic map reflecting a preset range in the vicinity of an exit of the parking lot (see a reference sign 204 in FIG. 3) on the high-precision three-dimensional map. The map generation unit 13 can specify the position and size of the virtual obstacle range from, for example, the scale of the dynamic map and the behavior observation device information included in the integrated virtual obstacle range information.

Note that, in the first embodiment, the map generation unit 13 reflects the dynamic information reflected in the dynamic map at the current time t also in future dynamic maps after the current time t. Therefore, in FIG. 3, the target vehicle is reflected in all of the dynamic map at the current time t and the future dynamic maps at three times (t+g, t+2g, and t+3g).

The map generation unit 13 outputs the generated dynamic map group to the map output unit 14.

The map output unit 14 outputs the dynamic map group output from the map generation unit 13 to the in-vehicle device 3.

Note that an area controlled by the server 1 is predetermined. The map output unit 14 outputs the dynamic map group to the in-vehicle device 3 mounted on an automatic operating vehicle present in the controlled area.

The in-vehicle device 3 that has acquired the dynamic map group plans a route on the basis of the acquired dynamic map group. Then, the in-vehicle device 3 performs automatic operating control on the basis of the planned route.

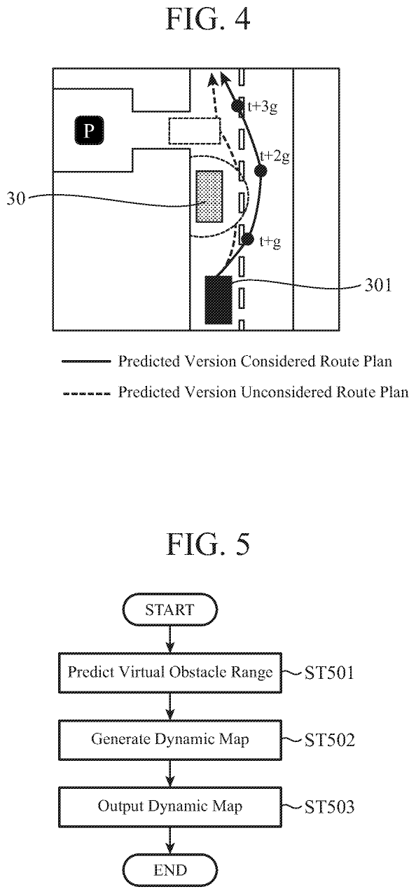

Here, FIG. 4 is a diagram illustrating an example of a route planned by the in-vehicle device 3 in the first embodiment.

FIG. 4 illustrates the example of a planned route when the in-vehicle device 3 acquires the dynamic map group including the dynamic map at the current time t and the future dynamic maps at three times (t+g, t+2g, and t+3g) as illustrated in FIG. 3. Note that, in the in-vehicle device 3, the planning unit 342 plans a route as described above.

In FIG. 4, a vehicle 30 on which the in-vehicle device 3 that plans a route on the basis of the dynamic map group is mounted (hereinafter, referred to as “route planning vehicle”) is represented by a reference sign 301.

In addition, in FIG. 4, a route planned by the in-vehicle device 3 on the basis of the dynamic map group is indicated by a solid line (“predicted version considered route plan” in FIG. 4). In FIG. 4, for comparison, a route planned by the in-vehicle device 3 only on the basis of the dynamic map at the current time t is indicated by a dotted line (“prediction version unconsidered route plan” in FIG. 4).

For example, at time t+2 g, it is predicted that a virtual obstacle range having a radius of 1.5 m from the center of a door of the target vehicle (vehicle 30 in FIG. 4) will appear.

If the in-vehicle device 3 plans a route only on the basis of the dynamic map at the current time t without considering the prediction, the route planning vehicle encounters a sudden change in the situation around the vehicle, that is, a situation in which the door of the target vehicle opens at the time t+2g. In this case, the in-vehicle device 3 cannot cope with this situation change in the automatic operating control, and may take abrupt control of the route planning vehicle.

Meanwhile, in the first embodiment, the in-vehicle device 3 plans a route on the basis of the dynamic map group, and therefore can predict, at the current time t, that a situation in which the door of the target vehicle opens at a time point at the time t+2g will be encountered. Then, in order to avoid the predicted situation in which the door of the target vehicle opens, the in-vehicle device 3 can plan a route that avoids the virtual obstacle range having a radius of 1.5 m from the center of the door of the target vehicle. As a result, the in-vehicle device 3 can avoid sudden control of the route planning vehicle in the automatic operating control. As a result, the in-vehicle device 3 can reduce, for example, an increased burden on an occupant due to sudden control.

In addition, the server 1 can support the in-vehicle device 3 for planning a route that can avoid sudden control by providing the dynamic map group to the in-vehicle device 3. As a result, the server 1 can reduce, for example, an increased burden on an occupant due to sudden control in the in-vehicle device 3.

An operation of the automatic operating system 100 according to the first embodiment will be described.

Hereinafter, operations of the server 1, the in-vehicle device 3, and the behavior observation device 4 constituting the automatic operating system 100 will be described with reference to flowcharts.

First, the operation of the server 1 will be described.

FIG. 5 is a flowchart for explaining the operation of the server 1 according to the first embodiment.

The server 1 predicts a virtual obstacle range (step ST501).

Specifically, in the server 1, the range prediction unit 12 predicts a virtual obstacle range on the basis of motion prediction information acquired by the information acquisition unit 11 from the in-vehicle device 3 or the behavior observation device 4.

The range prediction unit 12 outputs the virtual obstacle range information to the map generation unit 13.

The map generation unit 13 generates a dynamic map reflecting the virtual obstacle range on the basis of the virtual obstacle range information regarding the virtual obstacle range predicted by the range prediction unit 12 in step ST501 (step ST502).

Specifically, the map generation unit 13 generates a plurality of future dynamic maps reflecting the virtual obstacle range in time series for each map generation time g after the current time.

More specifically, the information integration unit 131 of the map generation unit 13 integrates the virtual obstacle range information output from the range prediction unit 12 and generates integrated virtual obstacle range information. Then, the map generation unit 13 generates a future dynamic map on the basis of the integrated virtual obstacle range information generated by the information integration unit 131.

The map generation unit 13 outputs the generated dynamic map group to the map output unit 14.

The map output unit 14 outputs the dynamic map group output from the map generation unit 13 in step ST502 to the in-vehicle device 3 (step ST503).

The in-vehicle device 3 that has acquired the dynamic map group plans a route on the basis of the acquired dynamic map group. Then, the in-vehicle device 3 performs automatic operating control on the basis of the planned route.

Note that although not described in the flowchart of FIG. 5, the server 1 also generates a current time dynamic map in addition to the operation described in the flowchart of FIG. 5.

Specifically, in the server 1, the information acquisition unit 11 acquires sensor information from the in-vehicle device 3 and the roadside device 5, and outputs the acquired sensor information to the map generation unit 13. Then, the map generation unit 13 generates a current time dynamic map.

The generation of the current time dynamic map may be performed in parallel with step ST502 or may be performed before step ST502.

Next, an operation of the in-vehicle device 3 will be described.

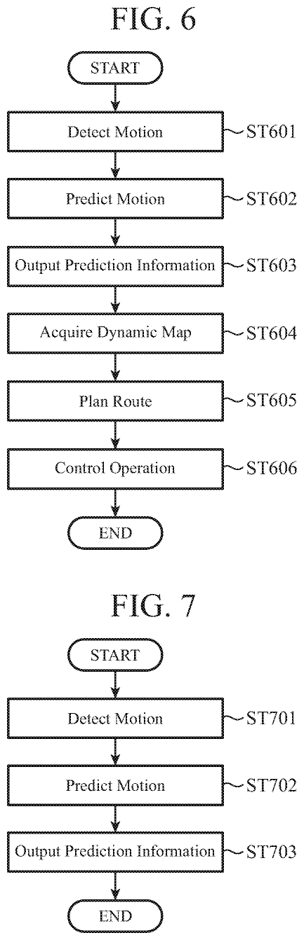

FIG. 6 is a flowchart for explaining the operation of the in-vehicle device 3 according to the first embodiment.

The automatic operating control device 34 includes the map acquisition unit 341, the planning unit 342, and the operating control unit 343.

The motion detection unit 31 detects a motion of a mobile object on the basis of acquired sensor information (step ST601).

The motion detection unit 31 outputs motion detection information indicating that the motion of the mobile object has been detected to the motion prediction unit 32. In addition, when acquiring the sensor information from the sensor 21, the motion detection unit 31 outputs the sensor information to the information output unit 33.

When the motion detection information is output from the motion detection unit 31 in step ST601, that is, when the motion detection unit 31 detects the motion of the mobile object on the basis of the sensor information, the motion prediction unit 32 predicts motions of the mobile object after the next time (step ST602).

The motion prediction unit 32 outputs the predicted motion prediction information regarding motions of the mobile object after the next time to the information output unit 33.

The information output unit 33 outputs the motion prediction information output from the motion prediction unit 32 in step ST602 to the server 1 (step ST603).

The map acquisition unit 341 acquires the dynamic map group output from the server 1 (step ST604).

The map acquisition unit 341 outputs the acquired map group to the planning unit 342.

The planning unit 342 makes an operation plan on the basis of the dynamic map group acquired by the map acquisition unit 341 in step ST604. Specifically, the planning unit 342 plans a route on the basis of the dynamic map group acquired by the map acquisition unit 341 (step ST605).

The planning unit 342 outputs information regarding the planned route to the operating control unit 343.

The operating control unit 343 controls automatic operation on the basis of the route planned by the planning unit 342 in step ST605.

Next, an operation of the behavior observation device 4 will be described.

FIG. 7 is a flowchart for explaining the operation of the behavior observation device 4 according to the first embodiment.

The motion detection unit 41 acquires sensor information from the sensor 22, and detects a motion of a mobile object on the basis of the acquired sensor information (step ST701).

The motion detection unit 41 outputs motion detection information indicating that the motion of the mobile object has been detected to the motion prediction unit 42.

When the motion detection information is output from the motion detection unit 41 in step ST701, that is, when the motion detection unit 41 detects the motion of the mobile object on the basis of the sensor information, the motion prediction unit 42 predicts motions of the mobile object after the next time (step ST702).

The motion prediction unit 42 outputs the predicted motion prediction information regarding motions of the mobile object after the next time to the information output unit 43.

The information output unit 43 outputs the motion prediction information output from the motion prediction unit 42 in step ST702 to the server 1.

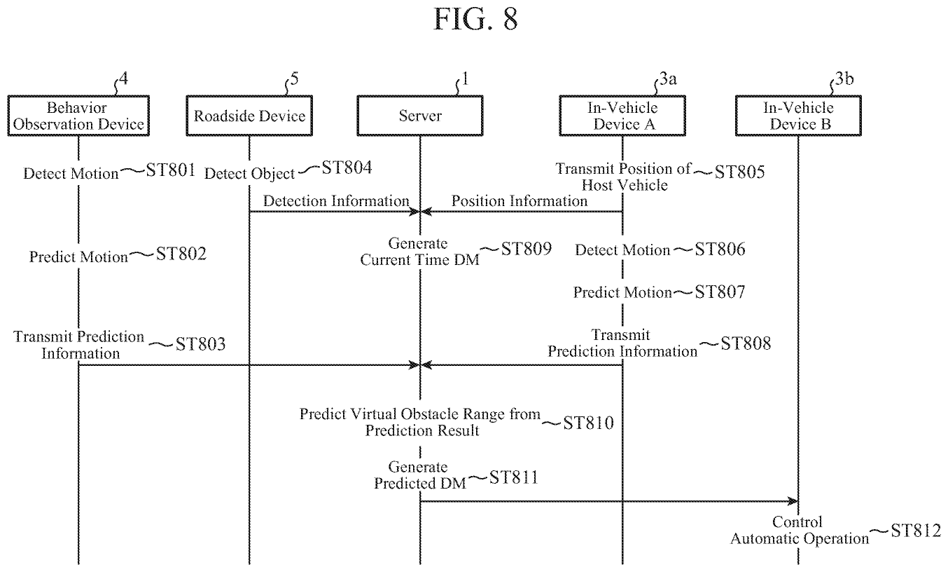

FIG. 8 is a sequence diagram for explaining an example of an operation of the automatic operating system in the first embodiment.

Note that in FIG. 8, the in-vehicle device 3 (in-vehicle device A (3a)) that outputs the motion prediction information to the server 1 and the in-vehicle device 3 (in-vehicle device B (3b)) that acquires the dynamic map group from the server 1 are different in-vehicle devices 3.

Steps ST801 to ST803 in FIG. 8 correspond to steps ST701 to ST703 in FIG. 7, respectively.

Step ST804 in FIG. 8 illustrates an operation in which the roadside device 5 outputs the sensor information acquired from the sensor 23 to the server 1 although description using a flowchart is omitted.

Step ST805 in FIG. 8 illustrates an operation in which the in-vehicle device 3 outputs the sensor information acquired from the sensor 21 to the server 1 although description using a flowchart is omitted.

Steps ST806 to ST808 in FIG. 8 correspond to steps ST601 to ST603 in FIG. 6, respectively.

Step ST809 in FIG. 8 illustrates an operation in which the map generation unit 13 generates a current time dynamic map on the basis of the sensor information acquired from the in-vehicle device 3 and the roadside device 5, in the server 1 although description using a flowchart is omitted.

Steps ST810 to ST811 in FIG. 8 correspond to steps ST502 to ST503 in FIG. 5, respectively.

Step ST812 in FIG. 8 corresponds to steps ST604 to ST606 in FIG. 6.

As described above, in the automatic operating system 100, the in-vehicle device 3 and the behavior observation device 4 predict the motion of the mobile object on the basis of the sensor information, and the server 1 predicts the virtual obstacle range on the basis of the motion prediction information regarding the motion of the mobile object predicted by the in-vehicle device 3 and the behavior observation device 4. Then, the server 1 generates, on the basis of information regarding a predicted deemed obstacle range, a dynamic map reflecting the deemed obstacle range.

As a result, the automatic operating system 100 can avoid sudden control of the route planning vehicle in the automatic operating control in the in-vehicle device 3. As a result, the in-vehicle device 3 can reduce, for example, an increased burden on an occupant due to sudden control.

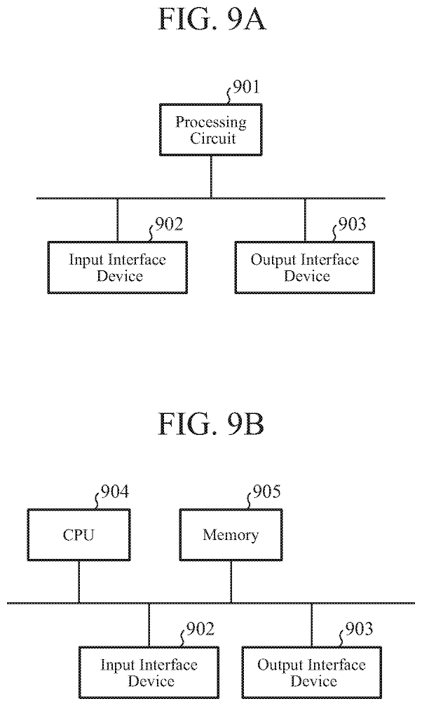

FIGS. 9A and 9B are each a diagram illustrating an example of a hardware configuration of the server 1 according to the first embodiment.

In the first embodiment, functions of the information acquisition unit 11, the range prediction unit 12, the map generation unit 13, and the map output unit 14 are implemented by a processing circuit 901. That is, the server 1 includes the processing circuit 901 for performing control to generate a future dynamic map reflecting the virtual obstacle range.

The processing circuit 901 may be dedicated hardware as illustrated in FIG. 9A or a central processing unit (CPU) 904 that executes a program stored in a memory 905 as illustrated in FIG. 9B.

When the processing circuit 901 is dedicated hardware, for example, a single circuit, a composite circuit, a programmed processor, a parallel programmed processor, an application specific integrated circuit (ASIC), a field-programmable gate array (FPGA), or a combination thereof corresponds to the processing circuit 901.

In a case where the processing circuit 901 is the CPU 904, functions of the information acquisition unit 11, the range prediction unit 12, the map generation unit 13, and the map output unit 14 are implemented by software, firmware, or a combination of software and firmware. The software or firmware is described as a program and stored in a memory 905. The processing circuit 901 executes the functions of the information acquisition unit 11, the range prediction unit 12, the map generation unit 13, and the map output unit 14 by reading and executing the program stored in the memory 905. That is, the server 1 includes the memory 905 for storing a program that causes steps ST501 to ST503 illustrated in FIG. 5 described above to be executed as a result when the program is executed by the processing circuit 901. It can also be said that the program stored in the memory 905 causes a computer to execute procedures or methods performed by the information acquisition unit 11, the range prediction unit 12, the map generation unit 13, and the map output unit 14. Here, for example, a nonvolatile or volatile semiconductor memory such as RAM, read only memory (ROM), flash memory, erasable programmable read only memory (EPROM), or electrically erasable programmable read-only memory (EEPROM), a magnetic disk, a flexible disk, an optical disc, a compact disc, a mini disc, or a digital versatile disc (DVD) corresponds to the memory 905.

Note that some of the functions of the information acquisition unit 11, the range prediction unit 12, the map generation unit 13, and the map output unit 14 may be implemented by dedicated hardware, and some of the functions may be implemented by software or firmware. For example, the functions of the information acquisition unit 11 and the map output unit 14 can be implemented by the processing circuit 901 as dedicated hardware, and the functions of the range prediction unit 12 and the map generation unit 13 can be implemented by the processing circuit 901 reading and executing a program stored in the memory 905.

In addition, the server 1 includes an input interface device 902 and an output interface device 903 that perform wired communication or wireless communication with a device such as the in-vehicle device 3, the behavior observation device 4, or the roadside device 5.

In the first embodiment described above, in the automatic operating system 100, the in-vehicle device 3 and the behavior observation device 4 include the motion prediction unit 32 and the motion prediction unit 42, respectively. However, it is not limited thereto, and the server may have the function of the motion prediction unit in the automatic operating system.

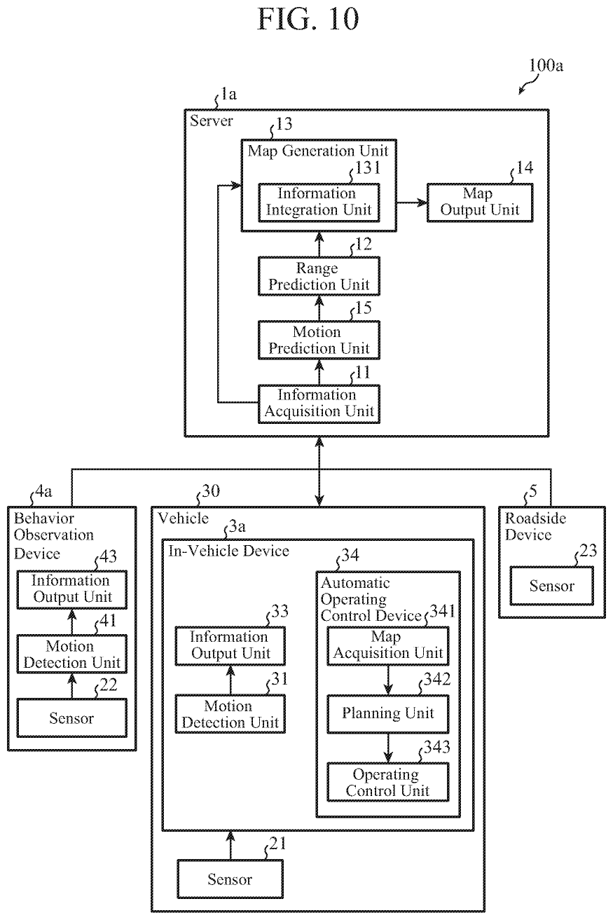

FIG. 10 is a diagram illustrating a configuration example of an automatic operating system 100a in which a server 1a has a function of a motion prediction unit 15 in the first embodiment. A specific function of the motion prediction unit 15 is similar to the specific functions of the motion prediction unit 32 and the motion prediction unit 42 described above, and therefore redundant description is omitted.

Note that, in this case, as illustrated in FIG. 10, an in-vehicle device 3a does not have to include the motion prediction unit 32. In addition, a behavior observation device 4a does not have to include the motion prediction unit 42.

In addition, in this case, the operation of step ST602 in FIG. 6 in the in-vehicle device 3a and the operation of step ST702 in FIG. 7 in the behavior observation device 4a are performed not in the in-vehicle device 3a and the behavior observation device 4a but in the server 1a before the operation of step ST501 in FIG. 5.

In addition, in the first embodiment described above, in the behavior observation device 4, the motion prediction unit 42 outputs the predicted motion prediction information regarding motions of the mobile object after the next time to the server 1. It is not limited thereto, and the motion prediction unit 42 may output the motion prediction information to the server 1 and output the motion prediction information to the in-vehicle device 3 as a preliminary value.

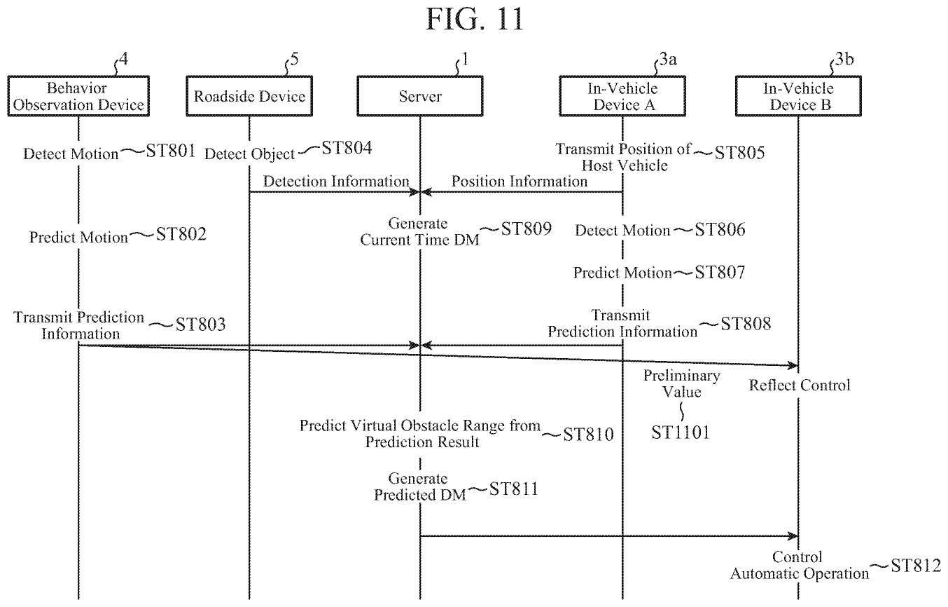

FIG. 11 is a sequence diagram for explaining an image of an operation of an automatic operating system in which the behavior observation device 4 outputs motion prediction information as a preliminary value to the in-vehicle device 3 in the first embodiment.

The sequence diagram of FIG. 11 is different from the sequence diagram of FIG. 8 in that step ST1101 is added.

In step ST1101, the behavior observation device 4 outputs the motion prediction information directly to the in-vehicle device 3 (in-vehicle device B (3b)) as a preliminary value.

Here, a case is considered in which the motion prediction information that is a result of predicting the motion of the mobile object in the behavior observation device 4 affects the vehicle 30 (hereinafter, referred to as “surrounding vehicle”) or the like present around the behavior observation device 4 before the server 1 reflects the motion prediction information in the dynamic map group. For example, it is assumed that the behavior observation device 4 predicts that the vehicle 30 (hereinafter, referred to as “parking-lot-exiting vehicle”) will exit to a public road after an elapse of a parking-lot-exiting period predicted from the time when a user ends fare adjustment. If the parking-lot-exiting period until the parking-lot-exiting vehicle exits to the public road is extremely short, the surrounding vehicle may encounter a situation in which another vehicle exits to the public road before acquiring the dynamic map group. In this case, sudden control may occur in the surrounding vehicle.

Therefore, in the behavior observation device 4, the motion prediction unit 42 outputs the motion prediction information to the server 1 and outputs the motion prediction information directly to the in-vehicle device 3 as a preliminary value. When acquiring the motion prediction information directly from the behavior observation device 4, the surrounding vehicle reflects the motion prediction information acquired from the behavior observation device 4 in the dynamic map group acquired from the server 1 last time, and re-searches for a route in automatic operation or operating assistance.

As a result, the surrounding vehicle can avoid sudden control even if a situation based on motion prediction information occurs before acquiring, from the server 1, the dynamic map group reflecting the motion prediction information that is a result of predicting the motion of the mobile object in the behavior observation device 4.

Note that, here, the description has been given assuming that the configuration of the automatic operating system 100 is as illustrated in FIG. 1, but the configuration of the automatic operating system 100a may be as illustrated in FIG. 10.

In addition, in the first embodiment described above, the behavior observation device 4 can also be applied to a bus operating system.

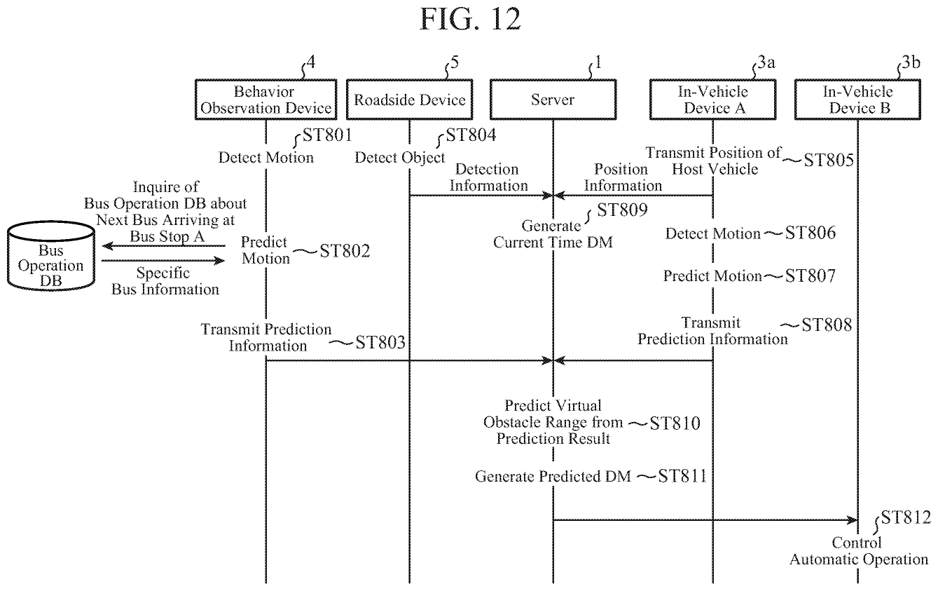

In this case, the behavior observation device 4 is disposed at a bus stop or in a bus. In the behavior observation device 4, the motion detection unit 41 detects whether or not there is a passenger waiting for a bus at a bus stop or whether or not there is a passenger waiting for getting off in the bus. For example, the behavior observation device 4 inquires of bus operation DB about a bus arriving at a certain bus stop (bus stop A, see FIG. 12 described later), and acquires information regarding the certain bus. It is assumed that the information regarding the certain bus includes information regarding whether or not there is a passenger waiting for the certain bus at a bus stop at which the certain bus arrives, or whether or not there is a passenger waiting for getting off in the certain bus.

When the motion detection unit 41 detects whether or not there is a passenger waiting for the bus or whether or not there is a passenger waiting for getting off in the bus, the motion prediction unit 42 predicts that a bus traveling toward the bus stop and traveling closest to the bus stop will stop at the bus stop after a predetermined time. Then, the motion prediction unit 42 transmits, to the server 1, motion prediction information indicating that the bus traveling toward the bus stop and traveling closest to the bus stop will stop at the bus stop after a predetermined time. In the server 1, the range prediction unit 12 predicts, as a virtual obstacle range, a range corresponding to the size of a specific bus in an assumed route through which the specific bus passes at each time before the specific bus stops at a road shoulder after a predetermined time, for example, from the motion prediction information output from the behavior observation device 4 and the dynamic map group generated last time.

In the server 1, the information integration unit 131 of the map generation unit 13 generates integrated virtual obstacle range information. The virtual obstacle range information integrated by the information integration unit 131 includes a virtual obstacle range predicted on the basis of a route through which the specific bus is assumed to pass before the specific bus stops at a road shoulder after a predetermined time. The map generation unit 13 generates a future dynamic map on the basis of the integrated virtual obstacle range information generated by the information integration unit 131. Then, the map output unit 14 outputs the dynamic map group to the in-vehicle device 3 mounted on an automatic operating vehicle present in a controlled area.

The in-vehicle device 3 that has acquired the dynamic map group plans a route on the basis of the acquired dynamic map group. Then, the in-vehicle device 3 performs automatic operating control on the basis of the planned route.

Note that, here, the description has been given assuming that the configuration of the automatic operating system 100 is as illustrated in FIG. 1, but the configuration of the automatic operating system 100a may be as illustrated in FIG. 10.

FIG. 12 is a sequence diagram for explaining an example of an operation of the automatic operating system 100 in a case where the behavior observation device 4 is applied to a bus operating system in the first embodiment.

Note that in FIG. 8, the in-vehicle device 3 (in-vehicle device A (3a)) that outputs the motion prediction information to the server 1 and the in-vehicle device 3 (in-vehicle device B (3b)) that acquires the dynamic map group from the server 1 are different in-vehicle devices 3.

The sequence diagram of FIG. 12 is different from the sequence diagram of FIG. 8 in that the behavior observation device 4 is used for a bus operating system and can access bus operation DB.

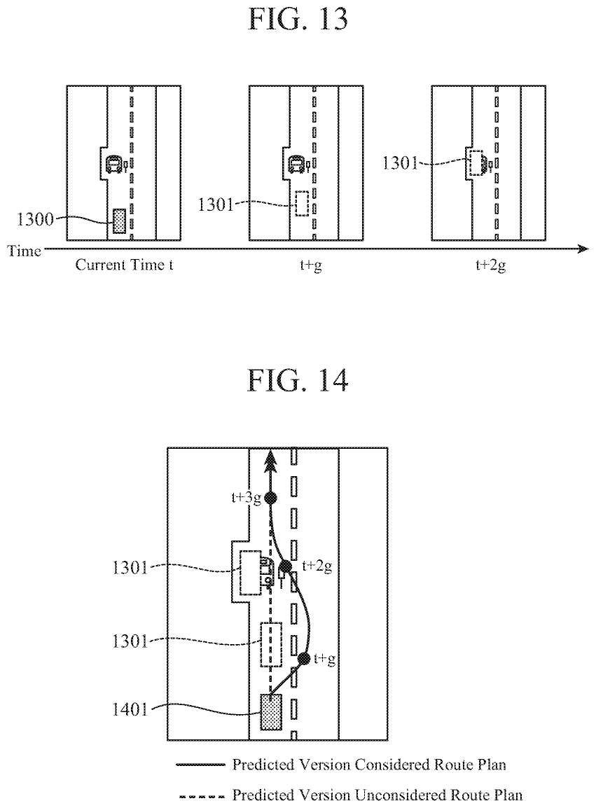

FIG. 13 is a diagram illustrating a concept of an example of a dynamic map group including a current time dynamic map and a plurality of future dynamic maps generated by the server 1 in a case where the behavior observation device 4 is applied to a bus operating system in the first embodiment. Note that the dynamic map is illustrated as a two-dimensional example in FIG. 13 for convenience of description.

In FIG. 13, the map generation unit 13 generates a dynamic map group including a dynamic map at the current time t and future dynamic maps corresponding to two times (time t+g and time t+2g) for each map generation time g after the current time.

Note that, in FIG. 13, the sensor information output from the information acquisition unit 11, that is, the sensor information at the current time t includes information indicating that a bus traveling toward a bus stop (see a reference sign 1300 in FIG. 13) has been detected.

As illustrated in FIG. 13, the map generation unit 13 generates, as the dynamic map at the current time t, a dynamic map reflecting bus information on the high-precision three-dimensional map.

In addition, the map generation unit 13 generates, as a future dynamic map at time t+g, a dynamic map reflecting a virtual obstacle range indicating a bus at time t+g (see a reference sign 1301 at t+g in FIG. 13) on the high-precision three-dimensional map.

In addition, the map generation unit 13 generates, as a future dynamic map at time t+2g, a dynamic map reflecting a virtual obstacle range indicating a bus at time t+2g (see a reference sign 1301 at t+2g in FIG. 13) on the high-precision three-dimensional map.

FIG. 14 is a diagram illustrating a concept of an example of a route planned by the in-vehicle device 3 on the basis of a dynamic map group generated by the server 1 in a case where the behavior observation device 4 is applied to a bus operating system in the first embodiment.

FIG. 14 illustrates the concept of the example of a planned route when the in-vehicle device 3 acquires the dynamic map group including the dynamic map at the current time t and the future dynamic maps at two times (t+g and t+2g) as illustrated in FIG. 13.

In FIG. 14, a route planning vehicle on which the in-vehicle device 3 that plans a route on the basis of the dynamic map group is mounted is represented by a reference sign 1401.

In addition, in FIG. 14, a route planned by the in-vehicle device 3 on the basis of the dynamic map group is indicated by a solid line (“predicted version considered route plan” in FIG. 14). In FIG. 14, for comparison, a route planned by the in-vehicle device 3 only on the basis of the dynamic map at the current time t is indicated by a dotted line (“prediction version unconsidered route plan” in FIG. 14).

For example, it is predicted that a virtual obstacle range corresponding to a bus that is going to stop at a bus stop will appear from time t+g to time t+2g.

If the in-vehicle device 3 plans a route only on the basis of the dynamic map at the current time t without considering the prediction, the route planning vehicle encounters, at the time t+2g, a sudden change in the situation around the vehicle, that is, a situation in which a bus stops and waits for departure due to stopping at a bus stop and picking up or dropping passengers. In this case, the in-vehicle device 3 cannot cope with this situation change in the automatic operating control, and may take abrupt control of the route planning vehicle.

On the other hand, when planning a route on the basis of the dynamic map group, at the current time t, the in-vehicle device 3 can predict that a situation in which a preceding bus stops at a bus stop and picks up or drops passengers will be encountered. Then, the in-vehicle device 3 can plan a route avoiding a virtual obstacle range corresponding to the bus so as to avoid the predicted situation in which the preceding bus stops at a bus stop and picks up or drops passengers. As a result, the in-vehicle device 3 can avoid sudden control of the route planning vehicle in the automatic operating control. As a result, the in-vehicle device 3 can reduce, for example, an increased burden on an occupant due to sudden control.

In addition, the server 1 can support the in-vehicle device 3 for planning a route that can avoid sudden control by providing the dynamic map group to the in-vehicle device 3. As a result, the server 1 can reduce, for example, an increased burden on an occupant due to sudden control in the in-vehicle device 3.

In addition, in the first embodiment described above, the in-vehicle device 3, 3a that has acquired the dynamic map group from the server 1 plans a route on the basis of the acquired dynamic map group, and performs automatic operating control on the basis of the planned route. It is not limited thereto, and the in-vehicle device 3, 3a that has acquired the dynamic map group from the server 1 may perform control such as attention calling to an occupant on the basis of the acquired dynamic map group.

In addition, in the first embodiment described above, the server 1 generates a plurality of future dynamic maps, but this is merely an example. The server 1 may generate one future dynamic map. In this case, the server 1 outputs a dynamic map group including a current time dynamic map and one future dynamic map to the in-vehicle device 3, 3a of the automatic operating vehicle.

In addition, in the first embodiment described above, the behavior observation device 4, 4a detects a pedestrian and predicts a motion of the pedestrian. This is merely an example, and the detection of the pedestrian and the prediction of the motion of the pedestrian may be performed by the server 1, 1a. For example, in the server 1, 1a, the information acquisition unit 11 may acquire a captured video captured by a camera from the roadside device 5, and the range prediction unit 12 may detect a pedestrian and predict in which direction and at what speed the detected pedestrian is walking.

In addition, in the first embodiment described above, the in-vehicle device 3, 3a includes the automatic operating control device 34, but this is merely an example. For example, the in-vehicle device 3, 3a does not have to include the automatic operating control device 34, and the automatic operating control device 34 may be provided in a place different from the in-vehicle device 3, 3a.

Note that, in the first embodiment described above, among the vehicles 30 connected to the server 1, a vehicle 30 that is not an automatic operating vehicle does not include the automatic operating control device 34.

In addition, in the first embodiment described above, a device outside the in-vehicle device 3, 3a may have the function of the motion detection unit 31. In this case, the in-vehicle device 3, 3a does not have to include the motion detection unit 31. In addition, in the first embodiment described above, for example, a device outside the behavior observation device 4, 4a may have the function of the motion detection unit 41. In this case, the behavior observation device 4, 4a does not have to include the motion detection unit 41.

In addition, in the first embodiment described above, the server 1 may include some or all of the motion detection unit 31, the motion prediction unit 32, the information output unit 33, the map acquisition unit 341, the planning unit 342, and the operating control unit 343 included in the in-vehicle device 3, 3a. In addition, the server 1 may include some or all of the components of the motion detection unit 41, the motion prediction unit 42, and the information output unit included in the behavior observation device 4, 4a.

As described above, according to the first embodiment, the automatic operating system 100, 100a includes: the motion prediction unit 32, 42 that predicts a motion of a mobile object on the basis of sensor information; the range prediction unit 12 that predicts a virtual obstacle range in which a virtual obstacle is considered to be present on the basis of motion prediction information regarding the motion of the mobile object predicted by the motion prediction unit 32, 42; and the map generation unit 13 that generates a dynamic map reflecting the virtual obstacle range on the basis of information regarding the virtual obstacle range predicted by the range prediction unit 12.

Therefore, in the automatic operating system 100, 100a that provides a generated dynamic map to a vehicle capable of automatic operation, sudden control of the vehicle capable of automatic operation can be avoided.

In addition, in the automatic operating system 100, 100a according to the first embodiment, the map generation unit 13 generates a plurality of dynamic maps reflecting the virtual obstacle range in time series for each map generation time after the current time.

Therefore, the automatic operating system 100, 100a can notify the vehicle 30, 30a that performs automatic operating control using the dynamic map of a predictable future surrounding situation change in a certain period. The automatic operating system 100, 100a can cause the vehicle 30, 30a to more accurately grasp a predictable future surrounding situation change and to search for a route. As a result, the automatic operating system 100, 100a can avoid sudden control of the vehicle 30 in the automatic operating control. As a result, the in-vehicle device 3 can reduce, for example, an increased burden on an occupant due to sudden control.

In addition, in the first embodiment, the automatic operating system 100, 100a includes: the map acquisition unit 341 that acquires a dynamic map generated by the map generation unit 13; the planning unit 342 that plans a route on the basis of the dynamic map acquired by the map acquisition unit 341; and the operating control unit 343 that performs automatic operating control according to the route planned by the planning unit 342.

Therefore, the automatic operating system 100, 100a can avoid sudden control of the vehicle 30 in the automatic operating control. As a result, the in-vehicle device 3 can reduce, for example, an increased burden on an occupant due to sudden control.

In addition, in the first embodiment, the server 1 includes: the information acquisition unit 11 that acquires motion prediction information regarding a motion of a mobile object predicted on the basis of sensor information; the range prediction unit 12 that predicts a virtual obstacle range in which a virtual obstacle is considered to be present on the basis of the motion prediction information acquired by the information acquisition unit 11; and the map generation unit 13 that generates a dynamic map reflecting the virtual obstacle range on the basis of information regarding the virtual obstacle range predicted by the range prediction unit 12. As a result, the server 1 can avoid sudden control of the route planning vehicle in the automatic operating control. As a result, the server 1 can reduce, for example, an increased burden on an occupant due to sudden control. In addition, the server 1 can support the in-vehicle device 3 for planning a route that can avoid sudden control by providing the dynamic map group to the in-vehicle device 3. As a result, the server 1 can reduce, for example, an increased burden on an occupant due to sudden control in the in-vehicle device 3.

Note that any component in the embodiment can be modified, or any component in the embodiment can be omitted.

### INDUSTRIAL APPLICABILITY

The automatic operating system according to the present disclosure can avoid, in an automatic operating system that provides a generated dynamic map to a vehicle capable of automatic operation, sudden control of the vehicle capable of automatic operation.

### REFERENCE SIGNS LIST

1, 1a: server, 11: information acquisition unit, 12: range prediction unit, 13: map generation unit, 131: information integration unit, 14: map output unit, 15: motion prediction unit, 21, 22, 23: sensor, 3, 3a: in-vehicle device, 31: motion detection unit, 32: motion prediction unit, 33: information output unit, 34: automatic operating control device, 341: map acquisition unit, 342: planning unit, 343: operating control unit, 4, 4a: behavior observation device, 41: motion detection unit, 42: motion prediction unit, 43: information output unit, 5: roadside device, 100, 100a: automatic operating system, 901: processing circuit, 902: input interface device, 903: output interface device, 904: CPU, 905: memory

1. An automatic operating system to provide at least one dynamic map to a vehicle capable of automatic operation, the automatic operating system comprising:
processing circuitry configured to
predict a motion of a mobile object on a basis of sensor information;
predict a virtual obstacle range in which a virtual obstacle is present on a basis of motion prediction information regarding the predicted motion of the mobile object; and
generate the at least one dynamic map reflecting the virtual obstacle range on a basis of information regarding the predicted virtual obstacle range.

2. The automatic operating system according to claim 1, wherein
the at least one dynamic map includes a plurality of dynamic maps, and
the processing circuitry is configured to generate the plurality of dynamic maps reflecting the virtual obstacle range in time series for each map generation time after a current time.

3. The automatic operating system according to claim 1,
wherein the processing circuitry is configured to
acquire the at least one dynamic map having been generated;
plan a route on a basis of the at least one dynamic map having been acquired; and
perform automatic operating control according to the planned route.

4. The automatic operating system according to claim 1, wherein
the processing circuitry is configured to predict that a door of the vehicle will open when detecting that an occupant of the vehicle has put his or her hand on the door on a basis of the sensor information.

5. The automatic operating system according to claim 1, wherein
the processing circuitry is configured to predict a motion in which the mobile object exits from a parking lot when detecting that an operation of a device disposed in the parking lot has been ended on a basis of operation information of the device.

6. The automatic operating system according to claim 1, wherein
the processing circuitry is configured to predict a motion of a pedestrian when detecting the pedestrian on a basis of a captured video.

7. The automatic operating system according to claim 1, comprising:
an in-vehicle device and a behavior observation device; and
a server including the processing circuitry.

8. A server to provide at least one dynamic map to a vehicle capable of automatic operation, the server comprising:
processing circuitry configured to
acquire motion prediction information regarding a motion of a mobile object predicted on a basis of sensor information;
predict a virtual obstacle range in which a virtual obstacle is present on a basis of the acquired motion prediction information; and
generate the at least one dynamic map reflecting the virtual obstacle range on a basis of information regarding the predicted virtual obstacle range.

9. The server according to claim 8,
wherein the processing circuitry is configured to predict a motion of the mobile object on a basis of sensor information,
and predict the virtual obstacle range on a basis of the motion prediction information regarding the predicted motion of the mobile object.

10. A method for generating at least one dynamic map by a server, the at least one dynamic map being provided to a vehicle capable of automatic operation, the method comprising:
acquiring motion prediction information regarding a motion of a mobile object predicted on a basis of sensor information;
predicting a virtual obstacle range in which a virtual obstacle is present on a basis of the acquired motion prediction information; and
generating the at least one dynamic map reflecting the virtual obstacle range on a basis of information regarding the predicted virtual obstacle range.
